(19) United States
(12) Patent Application Publication
(10) Pub. No.: US 2025/0142039 A1
(43) Pub. Date: May 1, 2025

(54) METHOD AND APPARATUS FOR GENERATING IMAGE, ELECTRONIC DEVICE, AND STORAGE MEDIUM

(71) Applicant: Douyin Vision Co., Ltd., Beijing (CN)

(72) Inventors: Cong XIE, Beijing (CN); Peiyao Zhao, Beijing (CN); Shaohui Jiao, Beijing (CN)

(21) Appl. No.: 18/889,226

(22) Filed: Sep. 18, 2024

(30) Foreign Application Priority Data
Oct. 25, 2023 (CN) 202311393636.2

(51) Int. Cl. H04N 13/156; G06T 5/50; G06T 7/11; G06T 7/50; G06T 7/90; G06T 17/20

(52) U.S. Cl. CPC H04N 13/156; G06T 5/50; G06T 7/11; G06T 7/50; G06T 7/90; G06T 17/20; G06T 2207/20221

(57) ABSTRACT

The present disclosure relates to an method and apparatus for generating an image, an electronic device, and a storage medium. The method includes: obtaining M original images of a target scene captured by M image acquisition devices, wherein each image acquisition device of the M image acquisition devices provides a different viewpoint of the target scene, and M is a positive integer greater than or equal to 8; performing, for each original image of the M original images, an image deformation process on the original image, based on depth information of the original image and internal and external parameters of the image acquisition device to obtain a deformed image; and performing a splicing process on M deformed images subjected to the image deformation process, to obtain an omni-directional stereo panoramic image.

### CROSS-REFERENCE TO RELATED APPLICATION(S)

This application claims priority to Chinese Application No. 202311393636.2 filed in Oct. 25, 2023, the disclosure of which is incorporated herein by reference in its entity.

### FIELD

The present disclosure relates to the technical field of image processing, and in particular, to a method and apparatus for generating an image, an electronic device, and a computer-readable storage medium.

### BACKGROUND

With the development of technologies such as Virtual Reality (VR), various VR devices have emerged. These VR devices can achieve system simulation of three-dimension dynamic scenes and physical behaviors, and support installation of application programs with various purposes. In addition, these VR devices are further installed with various native application programs to provide users with an immersive experience when the users use the application programs. Omni-Directional Stereo (ODS) is a projection model for 360-degree stereoscopic vision videos. The ODS can be used in conjunction with a VR Head Mounted Display (HMD) to display stereoscopic vision images. Through the ODS, the 360-degree stereoscopic vision videos can be stored, edited, and transmitted using conventional video formats and tools.

In the related technology, non-ODS binocular 360-degree video rendering means rendering panoramic images of the left and right eyes at positions spaced apart by a pupil distance. A user can watch the images on a VR HMD to achieve an immersive experience with binocular stereo perception. However, the problem of the non-ODS panorama is that only a Field of View (FOV) range of approximately 70 degrees in front has a correct stereo perception, objects on the left and right sides do not have parallax, and the left and right eyes are collinear with the objects; furthermore, an object in a back region has an opposite parallax, resulting in severe dizziness. Therefore, results of the non-ODS binocular 360-degree video rendering are generally not suitable for VR displaying.

The ODS binocular 360-degree video rendering mainly includes a ray tracing rendering scheme, a grid splicing rendering scheme, and an ODS offset rendering scheme. The ray tracing rendering scheme achieves ray tracing rendering based on viewpoints and lines of sight defined by an ODS camera model. Therefore, it is only applicable to a ray tracing rendering engine and not applicable to a raster rendering engine. In the grid splicing rendering scheme, an ODS sphere is divided into a plurality of small grids of horizontal 2 degrees×vertical 15 degrees, and each small grid is rendered and spliced one by one. Due to a large number of small grids, the computing amount is huge, much time is spent, and real-time rendering cannot be achieved. In the ODS offset rendering scheme, a position of an object in a camera coordinate system is modified in the raster rendering engine (i.e., ODS offset is superposed), so that a view vector from a viewpoint of a pinhole camera to a new position of the object obtained after offsetting is equivalent to a view vector from an ODS viewpoint to an original position of the object. Therefore, ODS images of the left/right eye can be obtained by rendering six surfaces of a cube through the ODS offset rendering and splicing panoramic images.

However, in the ODS offset rendering scheme, all shaders that involve coordinates of a vertex of the object in the raster rendering engine, including a shadow rendering component and a related screen post-treatment shader, need to be modified. Furthermore, it needs to ensure that a mesh model of the object does not include a triangular patch with an extremely large area. In a case that a user is not going to modify or is unable to modify all the shaders that involve the coordinates of the vertex in the raster rendering engine, the ODS offset rendering scheme will be no longer used.

Therefore, how to achieve real-time ODS video rendering of scenes in a raster rendering engine without modifying all shaders that involve coordinates of the vertex of the object in the raster rendering engine is an urgent problem that needs to be solved.

### SUMMARY

In view of this, the embodiments of the present disclosure provide an method and apparatus for generating an image, an electronic device, and a computer-readable storage medium, so as to solve the problems in the related technology.

A first aspect of the embodiments of the present disclosure provides a method for generating an image. The method includes: obtaining M original images of a target scene captured by M image acquisition devices, wherein each image acquisition device of the M image acquisition devices provides a different viewpoint of the target scene, and M is a positive integer greater than or equal to 8; performing, for each original image of the M original images, image deformation process on the original image based on depth information of the original image and internal and external parameters of the image acquisition device, to obtain a deformed image; and performing a splicing process on M deformed images subjected to the image deformation process, to obtain an omni-directional stereo panoramic image.

A second aspect of the embodiments of the present disclosure provides an apparatus for generating an image. The apparatus includes: an obtaining module configured to obtain M original images of a target scene captured by M image acquisition devices, wherein each image acquisition device of the M image acquisition devices provides a different viewpoint of the target scene, and M is a positive integer greater than or equal to 8; a deformation module configured to perform, for each original image of the M original images, an image deformation process on the original image based on depth information of the original image and internal and external parameters of the image acquisition device, to obtain a deformed image; and a splicing module configured to perform a splicing process on M deformed images subjected to the image deformation process, to obtain an omni-directional stereo panoramic image.

A third aspect of the embodiments of the present disclosure provides an electronic device, including: at least one processor; and a memory configured to store instructions executable by the at least one processor, wherein the at least one processor is configured to execute the instructions to implement the steps of the above method.

A fourth aspect of the embodiments of the present disclosure provides a computer-readable storage medium. Instructions in the computer-readable storage medium, when executed by a processor of an electronic device, cause the electronic device to execute the steps of the above method.

At least one of the above technical solutions used in the embodiments of the present disclosure can achieve the following beneficial effects: obtaining M original images of a target scene captured by M image acquisition devices, wherein each image acquisition device of the M image acquisition devices provides a different viewpoint of the target scene, and M is a positive integer greater than or equal to 8; performing, for each original image of the M original images, an image deformation process on the original image, based on depth information of the original image and internal and external parameters of the image acquisition device, to obtain a deformed image; and performing a splicing process on the M deformed images subjected to the image deformation process, to obtain an omni-directional stereo panoramic image. Thereby, without modifying all shaders that involve the coordinates of the vertex of the object in the raster rendering engine, the omni-directional stereo panoramic image can be obtained by performing the image deformation process and splicing process on the original images based on the depth information and the internal and external parameters of the image acquisition devices. Therefore, tensile distortion defects in a depth-image-based rendering process are reduced, a high-quality real-time rendering for omni-directional stereo videos is achieved, the operation efficiency is further improved, the operation cost is reduced, and the user experience is enhanced.

### BRIEF DESCRIPTION OF THE DRAWINGS

To describe the technical solutions in the embodiments of the present disclosure more clearly, the following briefly introduces the accompanying drawings for describing the embodiments or the existing technology. Apparently, the accompanying drawings in the following description show merely some embodiments of the present disclosure, and a person of ordinary skilled in the art may still derive other drawings from the accompanying drawings without creative efforts.

FIG. 1 is a schematic flowchart of a method for generating an image provided according to an exemplary embodiment of the present disclosure.

FIG. 2a is a top view of a left-eye layout of an omni-directional stereo camera provided according to an exemplary embodiment of the present disclosure.

FIG. 2b is a top view of a right-eye layout of an omni-directional stereo camera provided according to an exemplary embodiment of the present disclosure.

FIG. 2c is a side view of top and bottom layouts of an omni-directional stereo camera provided according to an exemplary embodiment of the present disclosure.

FIG. 2d is a comparison diagram between a layout of an omni-directional stereo camera and a traditional single-point equi-rectangular projection provided according to an exemplary embodiment of the present disclosure.

FIG. 3 is a schematic flowchart of another method for generating an image provided according to an exemplary embodiment of the present disclosure.

FIG. 4 is a schematic structural diagram of an apparatus for generating an image provided according to an exemplary embodiment of the present disclosure.

FIG. 5 is a schematic structural diagram of an electronic device provided according to an exemplary embodiment of the present disclosure.

FIG. 6 is a schematic structural diagram of a computer system provided according to an exemplary embodiment of the present disclosure.

### DETAILED DESCRIPTION OF EMBODIMENTS

The embodiments of the present disclosure will be described in detail below with reference to the accompanying drawings. Although the accompanying drawings show some embodiments of the present disclosure, it should be understood that the present disclosure can be implemented in various forms, and should not be explained as being limited to the embodiments stated herein. Rather, these embodiments are provided for understanding the present disclosure more thoroughly and completely. It should be understood that the accompanying drawings and embodiments of the present disclosure are only used for illustration, but are not intended to limit the protection scope of the present disclosure.

It should be understood that respective steps recorded in method implementations of the present disclosure can be executed in different orders and/or in parallel. In addition, the method implementations may include additional steps and/or omit the execution of the steps shown. The scope of the present disclosure is not limited in this aspect.

The term “include” and its variants as used herein mean widespread inclusion, namely, “including but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below. It should be noted that the concepts such as “first” and “second” mentioned in the present disclosure are only used to distinguish different apparatuses, modules, or units, and are not intended to limit the order or interdependence of the functions performed by these apparatuses, modules, or units.

It should be noted that the modifications of “one” and “plurality” mentioned in the present disclosure are indicative rather than restrictive, and a person skilled in the art should understand that unless otherwise explicitly stated in the context, they should be understood as “one or more”.

The names of messages or information exchanged between a plurality of apparatuses in the implementations of the present disclosure are only for illustrative purposes and are not intended to limit the messages or the scope of the information.

A method and apparatus for generating an image according to the embodiments of the present disclosure will be explained below in detail in combination with the accompanying drawings.

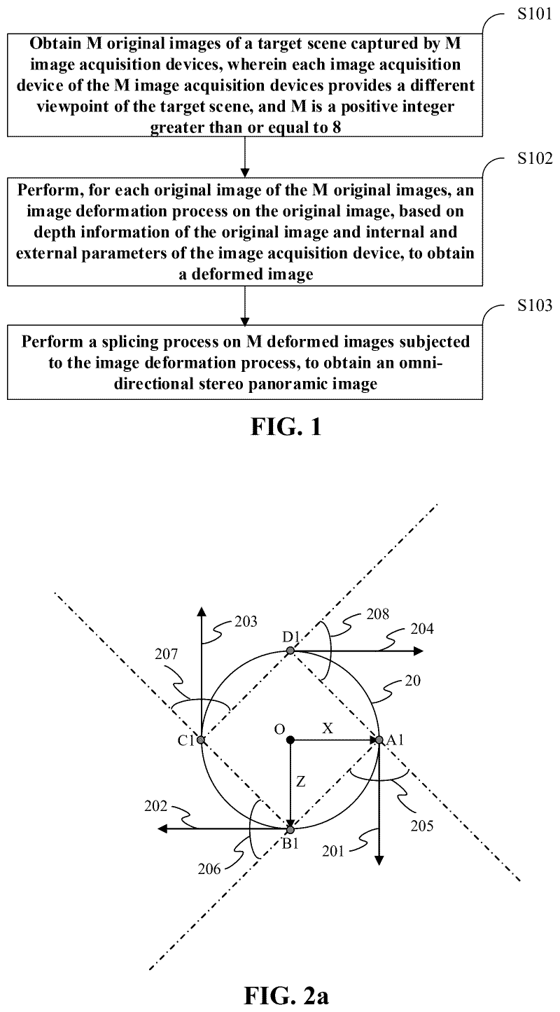

FIG. 1 is a schematic flowchart of a method for generating an image provided according to an exemplary embodiment of the present disclosure. The method for generating an image of FIG. 1 can be performed by a server. As shown in FIG. 1, the method for generating an image includes the following steps.

At S101, M original images of a target scene captured by M image acquisition devices are obtained, wherein each image acquisition device of the M image acquisition devices provides a different viewpoint of the target scene, and M is a positive integer greater than or equal to 8.

At S102, for each original image of the M original images, an image deformation process is performed on the original image, based on depth information of the original image and internal and external parameters of the image acquisition device, to obtain a deformed image.

At S103, a splicing process on is performed on M deformed images subjected to the image deformation process, to obtain an omni-directional stereo panoramic image.

Specifically, the M image acquisition devices can be used to capture the target scene to obtain the M original images of the target scene. The server obtains the M original images, and performs the image deformation process on each original image based on the depth information of each original image of the M original image and the internal and external parameters of the image acquisition device that captures the original image, to obtain the deformed image. Further, the server performs the splicing process on the M deformed images subjected to the image deformation process, to obtain the omni-directional stereo panoramic image.

The server may be an independent physical server, or may be a server cluster or a distributed system formed by a plurality of physical servers, or may be a cloud server that provides basic cloud computing service such as a cloud service, cloud database, cloud computing, cloud function, cloud storage, network service, cloud communication, middleware service, domain name service, security service, Content Delivery Networks (CDNs), big data, and artificial intelligence platform. The embodiments of the present disclosure will not limit this.

The image acquisition device is a device that uses an optical imaging principle to form an image and uses a negative film to record the image. It is an optical instrument for photographing. In the embodiments of the present disclosure, the image acquisition device is a camera. The camera captures the target scene according to a camera model to obtain an image. The camera model herein means that the camera captures a three-dimensional space where the target scene is located, projects the three-dimensional space where the target scene is located onto a two-dimensional flat image, and establishes a mapping relationship between the three-dimensional space and the two-dimensional flat image. The most common camera model is a pinhole camera model, and the fundamental assumption thereof is that light enters the camera through an infinitely small aperture (pinhole). The target scene is a scene presented in a space.

The camera may be an ODS camera and/or a depth sensing camera. The ODS camera may be a camera with a 360-degree field of view in a horizontal plane or a field of view that roughly covers the entire sphere. The depth sensing camera may create depth data for one or more objects captured within a range of the depth sensing camera. A field of view is also referred as an angle of field of view, which is an included angle formed by the two edges of the largest range that an object image of a captured target can pass through a lens, by using the camera as a vertex. The size of the angle of field of view determines a range of the visual field of the camera. A larger angle of field of view reflects a larger visual field.

A quantity and positions of cameras may be set according to an actual need. The embodiments of the present disclosure will not limit this. There are M cameras. M is a positive integer greater than or equal to 8. Preferably, in the embodiments of the present disclosure, M is equal to 10. Further, each camera of the M cameras can provide a different viewpoint of the target scene. In other words, each camera is arranged in a different direction to obtain images under a different field of view.

It should be noted that view frustums of adjacent cameras of the M cameras are fitted to each other to ensure the compactness and integrity of the captured images. The view frustum means a stereo shape obtained by cutting off a top end from a pyramid in a direction parallel to a bottom surface. This shape is a region that can be seen and be rendered by the camera.

The original image is an RGB depth (RGBD) image. The RGBD image may include an RGB image and a depth mage. A pixel value of each pixel point in the RGB image may be a color value of each point on a target surface. Usually, all colors that can be perceived by human vision are obtained by changing the three color channels of Red (R), Green (G), and Blue (B), and superposing the three color channels with each other. The pixel value of each pixel point in the depth image may be a distance between the depth camera and each point on the target surface. Due to the registration of the RGB image and the depth map, there is a one-to-one correspondence relationship between the pixel points of the RGB image and the pixel points of the depth image.

The internal and external parameters are internal and external parameters of the camera, including both an internal parameter and an external parameter. The internal parameter is a parameter related to the characteristics of the camera itself, including but not limited to 1/dx, 1/dy, u0, v0, r, f, etc. Herein, dx and dy represent length units respectively occupied by pixels in x and y directions, namely, an actual physical value represented by one pixel; u0 and v0 represent quantities of horizontal and longitudinal pixels between coordinates of a center pixel of an image and coordinates of a pixel of origin point of the image; r represents an aperture radius of the camera; and f represents a focal length of the camera. The external parameter is a parameter related to a coordinate system of the camera, including but not limited to ω, δ, θ, Tx, Ty, Tz, etc. Where ω, δ, and θ represent rotation parameters of the three axes of the three-dimensional coordinate system, and Tx, Ty, and Tz represent translation parameters of the three axes of the three-dimensional coordinate system.

Image warping/image deformation means transforming one image into another image according to a rule or method. In the image deformation technology, spatial mapping is a core means to achieve a change in an image structure. Through the spatial mapping, pixel points of some regions in the original image can be offset and mapped to other positions in the deformed image, so as to obtain, in the deformed image, a pixel point position relationship that is different from a previous pixel point position relationship, and thus achieving the purpose of changing the image structure. The image splicing is to splice a plurality of local images with overlapping parts into a seamless panoramic image. These images with the overlapping parts may be images obtained at different times, from different viewing angles, or by different sensors.

According to the technical solution provided in the embodiments of the present disclosure, M original images of the target scene captured by M cameras are obtained, wherein each camera of the M cameras provides a different viewpoint of the target scene, and M is a positive integer greater than or equal to 8; for each original image of the M original images, the image deformation process is performed on the original image based on depth information of the original image and internal and external parameters of the camera, to obtain a deformed image; and the splicing process on is performed the M deformed images subjected to the image deformation process, to obtain an omni-directional stereo panoramic image. Thereby, without modifying all shaders that involve the coordinates of the vertex of the object in the raster rendering engine, the omni-directional stereo panoramic image can be obtained by performing the image deformation process and splicing process on the original images based on the depth information and the internal and external parameters of the cameras. Therefore, tensile distortion defects in a depth-image-based rendering process are reduced, a high-quality real-time rendering for omni-directional stereo videos is achieved, the operation efficiency is further improved, the operation cost is reduced, and the user experience is enhanced.

In some embodiments, M original images of the target scene captured by M image acquisition devices are obtained, which includes: a center point of a pupil distance between a left eye and a right eye of a first device is determined as a center point of an omni-directional stereo camera coordinate system; two image acquisition devices of the M image acquisition devices are arranged at a top and a bottom of the first device in a vertical direction, based on the center point of the omni-directional stereo camera coordinate system, to obtain a top image and a bottom image; and an omni-directional stereo field-of-view circle is divided into N equal parts in a horizontal direction, based on the center point of the omni-directional stereo camera coordinate system, and 2N image acquisition devices are arranged at the N equal parts in a tangential manner, to obtain N left-eye images and N right-eye images, wherein N is a positive integer greater than or equal to 3 and less than M.

Specifically, VR is a technology for generating a virtual three-dimensional space through computer software and specialized hardware by using video/image, sound, or other information. The VR technology provides a user with an immersive virtual environment, making the user feel as if being physically present and be able to interact, move, control, and perform other operations in real time and without stint in a simulated three-dimensional space. In the embodiments of the present disclosure, the first device is a VR device. The VR device is a device capable of generating a virtual three-dimensional space to simulate perceptual functions such as vision, hearing, and touch for a user. Usually, the VR device is composed of a terminal device and a sensing device. The terminal device controls the sensing device. The sensing device uses a virtual reality technology to generate a virtual three-dimensional space. The VR device may be VR glasses, a VR head mounted display (HMD), or the like. The embodiments of the present disclosure does not limit this.

The pupil distance means a distance between the left pupil and the right pupil. In the embodiments of the present disclosure, the center point of the pupil distance can be determined as the center point of the omni-directional stereo camera coordinate system. After the center point of the omni-directional stereo camera coordinate system is determined, two cameras can be arranged at the top and bottom of the virtual reality device in the vertical direction based on the center point of the omni-directional stereo camera coordinate system to obtain a top image and a bottom image. Further, an omni-directional stereo field-of-view circle is divided into N equal parts in a horizontal direction, and 2N cameras are arranged at the N equal parts in a tangential manner, to obtain N left-eye images of the left eye and N right-eye images of the right eye.

N is a positive integer greater than or equal to 3 and less than M. A larger value of N indicates that the performance overheads for image acquisition are larger and the ODS distortion is smaller. Exemplarily, when N=3, due to the fact that the pinhole camera model is not an Equi-Angular Cube (EAC) projection, the resolution of a center region of an image is insufficient (i.e., the definition is insufficient). When N=4, it can meet the performance requirements, and distortion variables are controllable. In theory, increasing N can further reduce the tensile distortion defect in subsequent Depth-Image-Based Rendering (DIBR). For example, the effect of N=6 is better than that of N=4. Considering that the main performance overhead of rendering is the rendering time of a pinhole image, N=4 can better balance the performance and the effect. Therefore, in the embodiments of the present disclosure, N is preferred to be 4. When N=4, for the target scene, only 10 pinhole images with a field of view (FOV) of 90 degrees (including four left-eye images, four right-eye images, one top image, and one bottom image) need to be rendered, which reduces acquisition of two pinhole images compared with a non-ODS cube map.

According to the technical solution provided in the embodiments of the present disclosure, by optimizing the layout of the cameras for panoramic acquisition, the tensile distortion defect in the subsequent DIBR is reduced. Therefore, a high-quality real-time rendering of omni-directional stereoscopic videos is achieved, and the user experience is further enhanced.

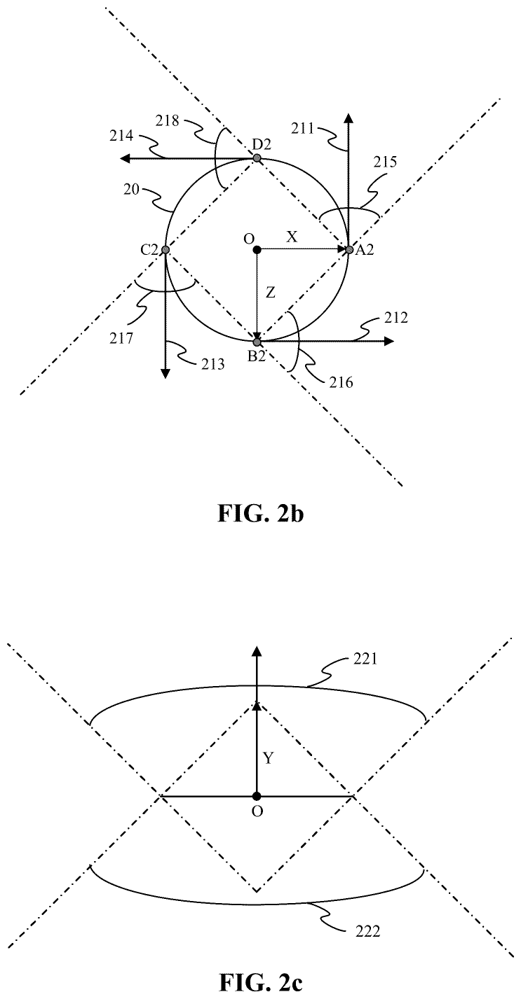

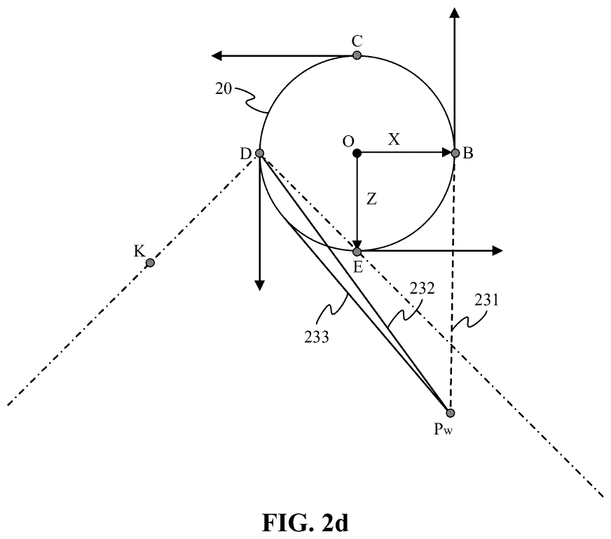

By taking N=4 as an example, the layout of the cameras of the embodiments of the present disclosure will be explained in detail below in conjunction with FIG. 2a to FIG. 2d.

FIG. 2a is a top view of a left-eye layout of an omni-directional stereo camera provided according to an exemplary embodiment of the present disclosure. As shown in FIG. 2a, “O” is a center point of a coordinate system of an ODS camera (i.e., a circle center of an ODS field-of-view circle 20); “X” is an X-axis of an ODS camera coordinate system; and “Z” is a Z-axis of the ODS camera coordinate system. Based on the center point “O”, the ODS field-of-view circle 20 is divided into four equal parts in a horizontal direction, and four cameras with FOVs of 90 degrees are respectively arranged at positions A1, B1, C1, and D1 of the ODS field-of-view circle 20. The camera arranged at position Al has a backward main view direction 201 and a backward view frustum 205; the camera arranged at position B1 has a leftward main view direction 202 and a leftward view frustum 206; the camera arranged at position C1 has a forward main view direction 203 and a forward view frustum 207; and the camera arranged at position D1 has a rightward main view direction 204 and a rightward view frustum 208. As shown in FIG. 2a, the main view direction of the camera is tangent to the ODS field-of-view circle 20, and the main view direction of the left eye is clockwise.

FIG. 2b is a top view of a right-eye layout of an omni-directional stereo camera provided according to an exemplary embodiment of the present disclosure. As shown in FIG. 2b, “O” is a center point of a coordinate system of an ODS camera (i.e., a circle center of an ODS field-of-view circle 20); “X” is an X-axis of an ODS camera coordinate system; and “Z” is a Z-axis of the ODS camera coordinate system. Based on the center point “O”, the ODS field-of-view circle 20 is divided into four equal parts in a horizontal direction, and four cameras with FOVs of 90 degrees are respectively arranged at positions A2, B2, C2, and D2 of the ODS field-of-view circle 20. The camera arranged at position A2 has a forward main view direction 211 and a forward view frustum 215; the camera arranged at position B2 has a rightward main view direction 212 and a rightward view frustum 216; the camera arranged at position C2 has a backward main view direction 213 and a backward view frustum 217; and the camera arranged at position D2 has a leftward main view direction 214 and a leftward view frustum 218. As shown in FIG. 2b, the main view direction of the camera is tangent to the ODS field-of-view circle 20, and the main view direction of the right eye is anticlockwise.

FIG. 2c is a side view of top and bottom layouts of an omni-directional stereo camera provided according to an exemplary embodiment of the present disclosure. As shown in FIG. 2c, “O” represents a center point of an ODS camera coordinate system, and “Y” represents a Y-axis of an ODS camera coordinate system. Based on the center point “O”, two cameras are respectively at a top and a bottom of a virtual reality device in a vertical direction. The camera arranged at the top has a top main view direction (not shown) and a top view frustum 221, and the camera arranged at the bottom has a bottom main view direction (not shown) and a bottom view frustum 222.

FIG. 2d is a comparison diagram between a layout of an omni-directional stereo camera and a traditional single-point equi-rectangular projection provided according to an exemplary embodiment of the present disclosure. As shown in FIG. 2d, “B” represents a capture viewpoint under a traditional two-point scheme; the dashed lines 231 represent a line of sight of a single-point Equi-Rectangular Projection (ERP); “D” represents a capture viewpoint under an ODS camera layout; the solid line 232 represents a capture line of sight of the ODS camera; the solid line 233 represents an ideal ODS line of sight. The ODS line of sight is tangent to the ODS field-of-view circle 20; and a point of tangency is an ODS viewpoint. By comparison with three lines of sight starting from “Pw”, it can be found that the capture line of sight under the ODS layout of the solid line 232 is closer to the ideal ODS line of sight, namely, an included angle between the lines of sight is smaller. Therefore, the ODS camera layout scheme is theoretically superior to the single-point ERP capture scheme.

In some embodiments, for each original image of the M original images, the image deformation process is performed on the original image based on depth information of the original image and internal and external parameters of the image acquisition device to obtain a deformed image, which includes: pixel coordinates of each mesh vertexe of the original image are converted into camera three-dimensional coordinates in the omni-directional stereo camera coordinate system based on the depth information and the internal and external parameters of the image acquisition device; the camera three-dimensional coordinates in the omni-directional stereo camera coordinate system are converted into spherical three-dimensional coordinates in the omni-directional stereo spherical coordinate system, and a three-dimensional mesh model is generated based on the spherical three-dimensional coordinates; and a mesh smoothing process is performed on the three-dimensional mesh model, and the three-dimensional mesh model subjected to the mesh smoothing process is flattened to obtain an omni-directional stereo flat mesh model used as the deformed image.

Specifically, the server can perform back projection on the each mesh vertex of the original image based on the depth information and the internal and external parameters of the image acquisition device; then, perform omni-directional stereo spherical projection on the mesh vertex subjected to the back projection; and generate a three-dimensional mesh model based on coordinates of the each mesh vertex subjected to the omni-directional stereo spherical projection. Further, the server performs mesh smoothing process on the three-dimensional mesh model and flattens the three-dimensional mesh model subjected to the meshing smoothing process to obtain the omni-directional stereo flat mesh model.

Herein, DIBR uses the depth information to project a reference image onto a three-dimensional Euclidean space, and then projects three-dimensional spatial points onto an imaging plane of a virtual camera. The DIBR technology can be regarded as three-dimensional spatial image transformation, which is referred to as a 3D image warping technology in computer graphics. The core of the DIBR technology is to use the depth information, which constructs three-dimensional information of a current viewpoint through the depth information, and then obtains three-dimensional information of other viewpoints through mapping transformation.

The omni-directional stereo camera coordinate system is a coordinate system formed by using an optical center of the ODS camera as an origin. The omni-directional stereo spherical coordinate system is a coordinate system that uses the following three coordinates to represent geometric shapes in a three-dimensional space: a radius distance from a point to a fixed origin, a zenith (or elevation) angle from a positive direction of the z-axis to the point, and an azimuth angle from a positive direction of the x-axis to an orthogonal projection of the point in an x-y plane.

The three-dimensional mesh model is a model composed of a plurality of meshes. A mesh is composed of numerous point clouds of tangible objects. The point clouds include three-dimensional coordinates (x, y, z), laser reflection intensity, color (RGB), and other information. The mesh is usually composed of a triangle, a quadrilateral, or other simple convex polygons, and can generate the three-dimensional mesh model based on the spherical three-dimensional coordinates.

After the three-dimensional mesh model is generated, the mesh smoothing process can be performed on the three-dimensional mesh model to remove inaccurate meshes or meshes, i.e. noisy meshes, that deviate significantly from an actual model, from the three-dimensional mesh model. The mesh smoothing algorithm may include, but is not limited to, a Taubin smoothing algorithm, a Laplacian smoothing algorithm, a mean curvature smoothing algorithm, and the like, and the embodiments of the present disclosure is not limited to this. Preferably, in the embodiments of the present disclosure, the three-dimensional mesh model is iteratively optimized for multiple times by using the Taubin smoothing algorithm to delete the noisy meshes.

It should be noted that in addition to the mesh smoothing processes mentioned above, a hole filling process can be further performed on the three-dimensional mesh model to make the three-dimensional mesh model more complete. Alternatively, mesh homogenization process can be further performed on the three-dimensional mesh model to prevent the meshes in the obtained three-dimensional mesh model being too dense or sparse.

According to the technical solution provided in the embodiments of the present disclosure, as the mesh smoothing process is performed on the three-dimensional mesh model, local sharp protrusions or recesses can be optimized, and the noisy meshes can be deleted. Therefore, the mesh generation efficiency is improved, the quality of generated meshes is optimized, and the appearance of the generated meshes is improved.

In some embodiments, the splicing process is performed on the M deformed images subjected to the image deformation process, to obtain the omni-directional stereo panoramic image, which includes: the M omni-directional stereo flat mesh models are rendered based on color information of the original images, to obtain the omni-directional stereo panoramic image.

Specifically, flat image meshes with texture maps are rendered into the omni-directional stereo panoramic image through an underlying rendering application program interface (API). Herein, rendering means a process of two-dimensional projecting an object model in a three-dimensional scene into a digital image according to set environment, material, lighting, and rendering parameters.

Texture is one or several two-dimensional images that represent details on surfaces of objects, also referred to as a texture image or a texture map. It can be understood that texture is actually a two-dimensional array. Elements in the two-dimensional array are some color values. When the texture is mapped to a surface of an object in a specific way, the object can be made to look like more real. The texture can be used for representing content included in an object that needs to be rendered onto a displayed image or a video frame.

The texture map can store a large amount of information. For example, each pixel can record information of at least one of colors, vertex data, normal vector, material, background light, scattering, highlight, transparency, geometric height, geometric displacement, and the like. The information can be used for depicting the details on the surface of the object. The texture map can be specifically a pre-drawn texture image. The texture image can include information such as colors corresponding to one or more graphic objects. For example, the graphic objects can include at least one of terrains, houses, trees, characters, and the like, under a three-dimensional scene.

All the optional technical solutions mentioned above can be combined in any way to form the optional embodiments of the present disclosure, and will not be elaborated here. In addition, in the above embodiments, an order of sequential numbers of the various steps does not indicate an execution sequence, and the execution sequence of the various processes should be determined according to functions and internal logics thereof and should not impose any limitation on an implementation process of the embodiments of the present disclosure.

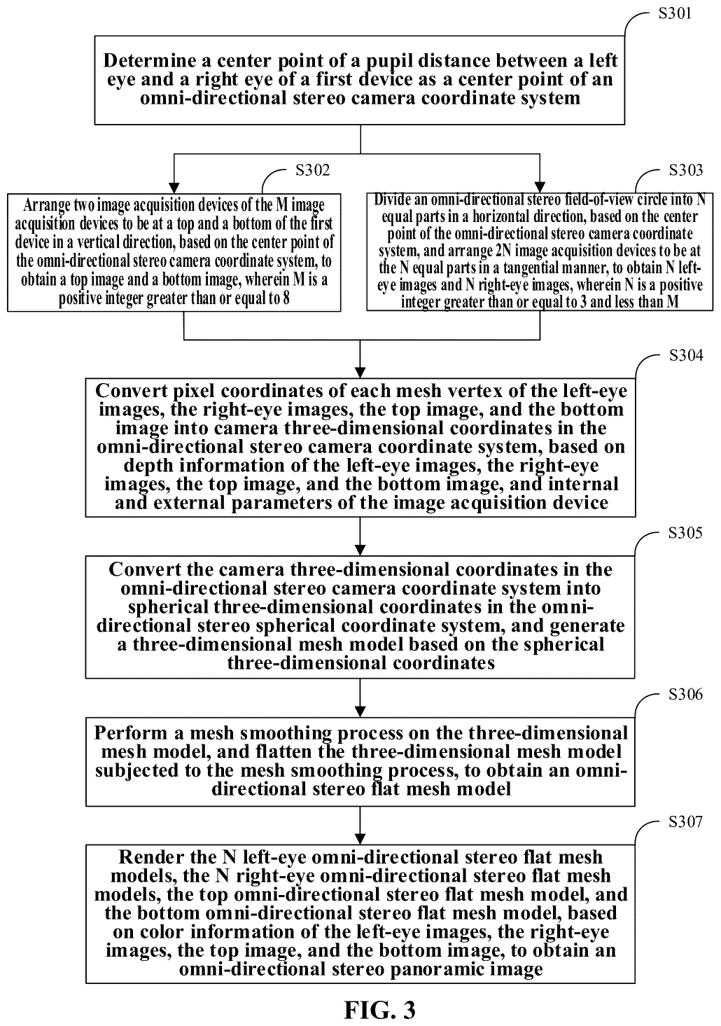

FIG. 3 is a schematic flowchart of another method for generating an image provided according to an exemplary embodiment of the present disclosure. The method for generating the image of FIG. 3 can be performed by a server. As shown in FIG. 3, the method for generating the image includes the following steps.

At S301, a center point of a pupil distance between the left eye and the right eye of a first device is determined as a center point of a omni-directional stereo camera coordinate system;

At S302, two image acquisition devices of M image acquisition devices are arranged at a top and a bottom of the first device in a vertical direction, based on the center point of the omni-directional stereo camera coordinate system, to obtain a top image and a bottom image, wherein M is a positive integer greater than or equal to 8.

At S303, an omni-directional stereo field-of-view circle is divided into N equal parts in a horizontal direction, based on the center point of the omni-directional stereo camera coordinate system, and 2N image acquisition devices are arranged at the N equal parts in a tangential manner, to obtain N left-eye images and N right-eye images, wherein N is a positive integer greater than or equal to 3 and less than M.

At S304, pixel coordinates of each mesh vertex of the left-eye images, the right-eye images, the top image, and the bottom image are converted into camera three-dimensional coordinates in the omni-directional stereo camera coordinate system, based on depth information of the left-eye images, the right-eye images, the top image, and the bottom image and internal and external parameters of the image acquisition devices.

At S305, the camera three-dimensional coordinates in the omni-directional stereo camera coordinate system are converted into spherical three-dimensional coordinates in the omni-directional stereo spherical coordinate system, and a three-dimensional mesh model is generated based on the spherical three-dimensional coordinates.

At S306, a mesh smoothing process is performed on the three-dimensional mesh model, and the three-dimensional mesh model subjected to the mesh smoothing process are flattened to obtain an omni-directional stereo flat mesh model.

At S307, the N left-eye omni-directional stereo flat mesh models, the N right-eye omni-directional stereo flat mesh models, the top omni-directional stereo flat mesh model, and the bottom omni-directional stereo flat mesh model are rendered based on color information of the left-eye images, the right-eye images, the top image, and the bottom image, to obtain an omni-directional stereo panoramic image.

According to the technical solution provided in the embodiments of the present disclosure, without modifying all shaders that involve the coordinates of the vertex of the object in the raster rendering engine, the omni-directional stereo panoramic image can be obtained by performing the image deformation process and splicing process on the images based on the depth information of the images and the internal and external parameters of the image acquisition devices. Therefore, tensile distortion defects in a depth-image-based rendering process are reduced, a high-quality real-time rendering for omni-directional stereo videos is achieved, the operation efficiency is further improved, the operation cost is reduced, and the user experience is enhanced.

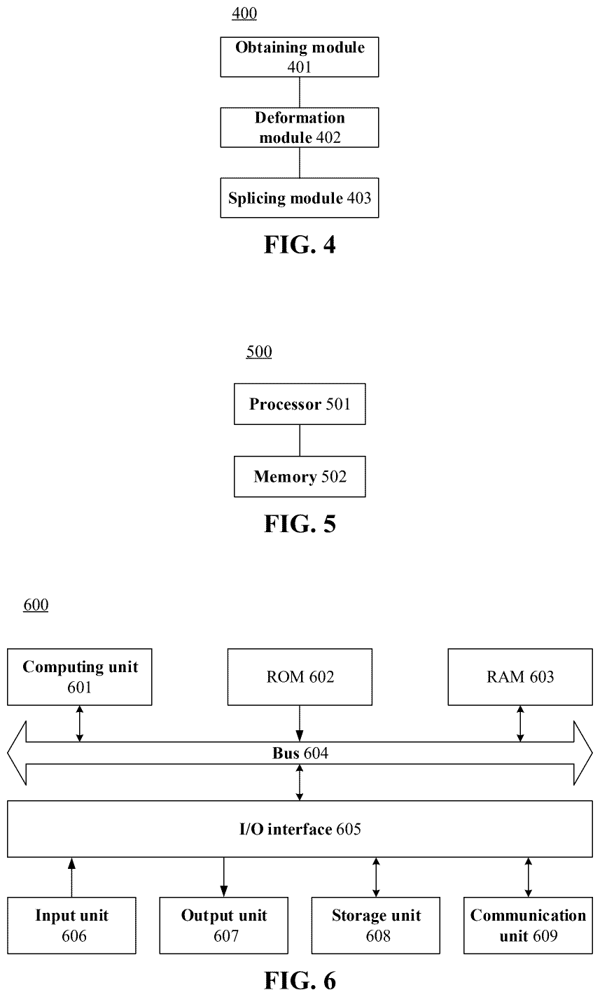

In a case of dividing various functional modules according to corresponding functions, the embodiments of the present disclosure provide an apparatus for generating an image. The apparatus for generating the image can be a server or a chip applied to a server. FIG. 4 is a schematic structural diagram of an apparatus for generating an image provided according to an exemplary embodiment of the present disclosure. As shown in FIG. 4, the apparatus for generating the image 400 includes the following modules.

An obtaining module 401 is configured to obtain M original images of a target scene captured by M image acquisition devices, wherein each image acquisition device of the M image acquisition devices provides a different viewpoint of the target scene, and M is a positive integer greater than or equal to 8.

A deformation module 402 is configured to perform, for each original image of the M original images, an image deformation process on the original image, based on depth information of the original image and internal and external parameters of the image acquisition device, to obtain a deformed image.

A splicing module 403 is configured to perform a splicing process on M deformed images subjected to the image deformation process, to obtain an omni-directional stereo panoramic image.

According to the technical solution provided in the embodiments of the present disclosure, M original images of the target scene captured by M image acquisition devices are obtained, wherein each image acquisition device of the M image acquisition devices provides a different viewpoint of the target scene, and M is a positive integer greater than or equal to 8; for each original image of the M original images, the image deformation process is performed on the original image based on depth information of the original image and internal and external parameters of the image acquisition device, to obtain a deformed image; and the splicing process on is performed the M deformed images subjected to the image deformation process, to obtain an omni-directional stereo panoramic image. Thereby, without modifying all shaders that involve the coordinates of the vertex of the object in the raster rendering engine, the omni-directional stereo panoramic image can be obtained by performing the image deformation process and splicing process on the original images based on the depth information and the internal and external parameters of the image acquisition devices. Therefore, tensile distortion defects in a depth-image-based rendering process are reduced, a high-quality real-time rendering for omni-directional stereo videos is achieved, the operation efficiency is further improved, the operation cost is reduced, and the user experience is enhanced.

In some embodiments, the obtaining module 401 of FIG. 4 is configured to determine a center point of a pupil distance between the left eye and the right eye of a first device as a center point of an omni-directional stereo camera coordinate system; arrange two image acquisition devices of the M image acquisition devices at a top and a bottom of the first device in a vertical direction, based on the center point of the omni-directional stereo camera coordinate system, to obtain a top image and a bottom image; and divide an omni-directional stereo field-of-view circle into N equal parts in a horizontal direction, based on the center point of the omni-directional stereo camera coordinate system, and arrange 2N image acquisition devices at the N equal parts in a tangential manner, to obtain N left-eye images and N right-eye images, wherein N is a positive integer greater than or equal to 3 and less than M.

In some embodiments, when N is equal to 4, M is equal to 10.

In some embodiments, the deformation module 402 of FIG. 4 is configured to convert pixel coordinates of each mesh vertex of the original image into camera three-dimensional coordinates in the omni-directional stereo camera coordinate system, based on the depth information and the internal and external parameters of the image acquisition device; convert the camera three-dimensional coordinates in the omni-directional stereo camera coordinate system into spherical three-dimensional coordinates in the omni-directional stereo spherical coordinate system, and generate a three-dimensional mesh model based on the spherical three-dimensional coordinates; and perform a mesh smoothing process on the three-dimensional mesh model, and flatten the three-dimensional mesh model subjected to the mesh smoothing process, to obtain an omni-directional stereo flat mesh model as the deformed image.

In some embodiments, the deformation module 402 of FIG. 4 is configured to iteratively optimize the three-dimensional mesh model for multiple times through a mesh smoothing algorithm to obtain an optimized three-dimensional mesh model.

In some embodiments, the splicing module 403 of FIG. 4 is configured to render the M omni-directional stereo flat mesh models based on color information of the original images to obtain the omni-directional stereo panoramic image.

In some embodiments, view frustums of the respective image acquisition devices of the M image acquisition devices are fitted to each other, and the original images are RGB depth images.

Specific implementation processes of the functions and roles of the various modules in the above apparatus can be found in the implementation processes of the corresponding steps of the above method, and will not be elaborated here.

The embodiments of the present disclosure further provide an electronic device, including: at least one processor; and a memory configured to store instructions executable by the at least one processor, wherein the at least one processor is configured to execute the instructions to implement the steps of the above method disclosed in the embodiments of the present disclosure.

FIG. 5 is a schematic structural diagram of an electronic device provided according to an exemplary embodiment of the present disclosure. As shown in FIG. 5, the electronic device 500 includes at least one processor 501 and a memory 502 coupled to the processor 501. The processor 501 can execute the corresponding steps of the above method disclosed in the embodiments of the present disclosure.

The above processor 501 can be further referred to as a Central Processing Unit (CPU), which can be an integrated circuit chip with a signal processing capability. All the steps of the above method disclosed in the embodiments of the present disclosure can be completed through an integrated logic circuit of hardware in the processor 501 or instructions in the form of software. The above processor 501 can be a general-purpose processor, a digital signal processing (DSP), an application specific integrated circuit (ASIC), a field-programmable gate array (FPGA), or other programmable logic devices, discrete gates, transistor logic devices, or discrete hardware components. The general-purpose processor may be a microprocessor, or the processor may be any conventional processor, or the like. The steps of the method disclosed in the embodiments of the present disclosure can be directly performed and completed by a hardware decoding processor, or performed and completed by combining hardware and software modules in a decoding processor. The software module may be located in the memory 502, for example, a storage medium that is mature in the art, such as a random access memory, a flash memory, a read only memory, a programmable read only memory, an electrically erasable programmable memory, and a register. The processor 501 reads information in the memory 502 and completes the steps of the above method in conjunction with the hardware of the processor.

In addition, according to a situation where various operations/processing of the present disclosure are implemented through software and/or firmware, a program constituting the software can be installed from a storage medium or network into a computer system, i.e. a computer system 600 shown in FIG. 6, which has a dedicated hardware architecture. The computer system can perform various functions, including the foregoing functions and the like, when being installed with various programs. FIG. 6 is a schematic structural diagram of a computer system provided according to an exemplary embodiment of the present disclosure.

The computer system 600 is designated to represent various forms of digital electronic computer devices, such as a laptop, a desktop computer, a workbench, a personal digital assistant, a server, a blade server, a large computer, and other suitable computers. The electronic device can further represent mobile devices in various forms, such as a personal digital assistant, a cellular phone, a smartphone, a wearable device, and other similar computing apparatuses. The components, their connections and relationships, and their functions shown herein are only examples and are not intended to limit the implementation described and/or required herein.

As shown in FIG. 6, the computer system 600 includes a computing unit 601. The computing unit 601 can perform various appropriate actions and processing according to computer programs stored in a ROM 602 or loaded into a RAM 603 from a storage unit 608. Various programs and data required for operations of the computer system 600 may alternatively be stored in the RAM 603. The computing unit 601, the ROM 602, and the RAM 603 are connected to each other through a bus 604. An Input/Output (I/O) interface 605 is also connected to the bus 604.

Multiple components in the computing system 600 are connected to the I/O interface 605, including: an input unit 606, an output unit 607, the storage unit 608, and a communication unit 609. The input unit 606 may be any type of device that can input information to the computer system 600, and the input unit 606 can receive input numeric or character information and generate key signal inputs related to user settings and/or function control of the electronic device. The output unit 607 may be any type of device capable of presenting information, and may include but not be limited to a display, a speaker, a video/audio output terminal, a vibrator, and/or a printer. The storage unit 608 may include, but not limited to, a magnetic disk and a compact disc. The communication unit 609 allows the computer system 600 to exchange information/data with other devices through a network such as the Internet, and may include, but not limited to, a modem, a network card, an infrared communication device, a wireless communication transceiver, and/or a chipset, such as a Bluetooth™ device, a WiFi device, a WiMax device, a cellular communication device, and/or a similar device.

The computing unit 601 may be various general and/or specialized processing components with processing and computing capabilities. Some examples of the computing unit 601 include but are not limited to a CPU, a graphics processing unit (GPU), various dedicated artificial intelligence (AI) computing chips, various computing units that run machine learning model algorithms, DSPs, any appropriate processors, controllers, microcontrollers, and the like. The computing unit 601 performs the various methods and processing described above. For example, in some embodiments, the above method disclosed by the embodiments of the present disclosure may be implemented as a computer software program that is tangibly included in a machine-readable medium, such as the storage unit 608. In some embodiments, part of or all computer programs may be loaded and/or installed onto the electronic device 600 via the ROM 602 and/or the communication unit 609. In some embodiments, the computing unit 601 may be configured to perform the above method disclosed by the embodiments of the present disclosure in any other suitable manners (such as by means of firmware).

The embodiments of the present disclosure further provide a computer-readable storage medium. Instructions in the computer-readable storage medium, when executed by a processor of an electronic device, cause the electronic device to perform the above method disclosed by the embodiments of the present disclosure.

The computer-readable storage medium in the embodiments of the present disclosure may be a tangible medium that may include or store a program for use by an instruction execution system, apparatus, or device or in connection with the instruction execution system, apparatus, or device. The above computer-readable storage medium may include but not limited to electronic, magnetic, optical, electromagnetic, infrared, or semiconductor systems, apparatuses, or devices, or any suitable combination of the above content. More specifically, the above computer-readable storage medium may include electrical connections based on one or more wires, a portable computer disk, a hard disk drive, a RAM, a ROM, an EPROM or flash memory, an optical fiber, compact disc read only memory (CD-ROM), an optical storage device, a magnetic storage device, or any suitable combination of the above content.

The computer-readable medium may be included in the electronic device or exist alone and is not assembled into the electronic device.

The embodiments of the present disclosure further provide a computer program product, including a computer program. The computer program, when run by a processor, implements the method provided in the embodiments of the present disclosure.

In the embodiments of the present disclosure, computer program codes for performing the operations of the present disclosure may be written in one or more programming languages or a combination thereof. The above programming languages include but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks (including a local area network (LAN) or a wide area network (WAN), or can be connected to an external computer.

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The modules, components, or units described in the embodiments of the present disclosure can be implemented through software or hardware. The names of the modules, components, or units do not constitute a limitation on the modules, components, or units themselves in a situation. The functions described herein above may be performed, at least in part, by one or a plurality of hardware logic components. For example, nonrestrictively, exemplary hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

The above description is only for explaining some embodiments of the present disclosure and technical principles used in the embodiments. A person skilled in the art should understand that the scope of disclosure referred to in the present disclosure is not limited to the technical solutions formed by specific combinations of the aforementioned technical features, but also covers other technical solutions formed by any combinations of the aforementioned technical features or their equivalent features without departing from the concept of the above disclosure, for example, a technical solution formed by replacing the above features with (but not limited to) technical features with similar functions disclosed in the present disclosure.

Although some specific embodiments of the present disclosure have been explained in detail through examples, a person skilled in the art should understand that the above examples are for illustration purposes only and not to limit the scope of the present disclosure. A person skilled in the art should understand that the above embodiments can be modified without departing from the scope and spirit of the present disclosure. The scope of the present disclosure is subject to the appended claims.

I/We claim:

1. A method for generating an image, comprising:
obtaining M original images of a target scene captured by M image acquisition devices, wherein each image acquisition device of the M image acquisition devices provides a different viewpoint of the target scene, and M is a positive integer greater than or equal to 8;
performing, for each original image of the M original images, an image deformation process on the original image, based on depth information of the original image and internal and external parameters of the image acquisition device, to obtain a deformed image; and
performing a splicing process on M deformed images subjected to the image deformation process, to obtain an omni-directional stereo panoramic image.

2. The method according to claim 1, wherein obtaining M original images of the target scene captured by M image acquisition devices comprises:
determining a center point of a pupil distance between a left eye and a right eye of a first device as a center point of an omni-directional stereo camera coordinate system;
arranging two image acquisition devices of the M image acquisition devices to be at a top and a bottom of the first device in a vertical direction, based on the center point of the omni-directional stereo camera coordinate system, to obtain a top image and a bottom image; and
dividing an omni-directional stereo field-of-view circle into N equal parts in a horizontal direction, based on the center point of the omni-directional stereo camera coordinate system, and arranging 2N image acquisition devices to be at the N equal parts in a tangential manner, to obtain N left-eye images and N right-eye images, wherein N is a positive integer greater than or equal to 3 and less than M.

3. The method according to claim 2, wherein in a case that N is equal to 4, M is equal to 10.

4. The method according to claim 2, wherein performing, for each original image of the M original images, the image deformation process on the original image, based on depth information of the original image and internal and external parameters of the image acquisition device, to obtain the deformed image comprises:
converting pixel coordinates of each mesh vertex of the original image into camera three-dimensional coordinates in the omni-directional stereo camera coordinate system, based on the depth information and the internal and external parameters of the image acquisition device;
converting the camera three-dimensional coordinates in the omni-directional stereo camera coordinate system into spherical three-dimensional coordinates in the omni-directional stereo spherical coordinate system, and generating a three-dimensional mesh model based on the spherical three-dimensional coordinates; and
performing a mesh smoothing process on the three-dimensional mesh model, and flattening the three-dimensional mesh model subjected to the mesh smoothing process, to obtain an omni-directional stereo flat mesh model as the deformed image.

5. The method according to claim 4, wherein the performing the mesh smoothing process on the three-dimensional mesh model comprises:
iteratively optimizing the three-dimensional mesh model for multiple times by a mesh smoothing algorithm, to obtain an optimized three-dimensional mesh model.

6. The method according to claim 4, wherein performing the splicing process on the M deformed images subjected to the image deformation process, to obtain the omni-directional stereo panoramic image comprises:
rendering M omni-directional stereo flat mesh models based on color information of the original images, to obtain the omni-directional stereo panoramic image.

7. The method according to claim 1, wherein view frustums of respective image acquisition devices of the M image acquisition devices are fitted to each other, and the original images are RGB depth images.

8. An electronic device, comprising:
at least one processor; and
a memory configured to store instructions executable by the at least one processor,
wherein the at least one processor is configured to execute the instructions to:
obtain M original images of a target scene captured by M image acquisition devices, wherein each image acquisition device of the M image acquisition devices provides a different viewpoint of the target scene, and M is a positive integer greater than or equal to 8;
perform, for each original image of the M original images, an image deformation process on the original image, based on depth information of the original image and internal and external parameters of the image acquisition device, to obtain a deformed image; and
perform a splicing process on M deformed images subjected to the image deformation process, to obtain an omni-directional stereo panoramic image.

9. The electronic device according to claim 8, wherein the instructions to obtain M original images of the target scene captured by M image acquisition devices comprise instructions to:
determine a center point of a pupil distance between a left eye and a right eye of a first device as a center point of an omni-directional stereo camera coordinate system;
arrange two image acquisition devices of the M image acquisition devices to be at a top and a bottom of the first device in a vertical direction, based on the center point of the omni-directional stereo camera coordinate system, to obtain a top image and a bottom image; and
divide an omni-directional stereo field-of-view circle into N equal parts in a horizontal direction, based on the center point of the omni-directional stereo camera coordinate system, and arrange 2N image acquisition devices to be at the N equal parts in a tangential manner, to obtain N left-eye images and N right-eye images, wherein N is a positive integer greater than or equal to 3 and less than M.

10. The electronic device according to claim 9, wherein in a case that N is equal to 4, M is equal to 10.

11. The electronic device according to claim 9, wherein the instructions to perform, for each original image of the M original images, the image deformation process on the original image, based on depth information of the original image and internal and external parameters of the image acquisition device, to obtain the deformed image comprise instructions to:
convert pixel coordinates of each mesh vertex of the original image into camera three-dimensional coordinates in the omni-directional stereo camera coordinate system, based on the depth information and the internal and external parameters of the image acquisition device;
convert the camera three-dimensional coordinates in the omni-directional stereo camera coordinate system into spherical three-dimensional coordinates in the omni-directional stereo spherical coordinate system, and generate a three-dimensional mesh model based on the spherical three-dimensional coordinates; and
perform a mesh smoothing process on the three-dimensional mesh model, and flatten the three-dimensional mesh model subjected to the mesh smoothing process, to obtain an omni-directional stereo flat mesh model as the deformed image.

12. The electronic device according to claim 11, wherein the instructions to perform the mesh smoothing process on the three-dimensional mesh model comprise instructions to:
iteratively optimize the three-dimensional mesh model for multiple times by a mesh smoothing algorithm, to obtain an optimized three-dimensional mesh model.

13. The electronic device according to claim 11, wherein the instructions to perform the splicing process on the M deformed images subjected to the image deformation process, to obtain the omni-directional stereo panoramic image comprise instructions to:
render M omni-directional stereo flat mesh models based on color information of the original images, to obtain the omni-directional stereo panoramic image.

14. The electronic device according to claim 8, wherein view frustums of respective image acquisition devices of the M image acquisition devices are fitted to each other, and the original images are RGB depth images.

15. A non-transitory computer-readable storage medium, wherein instructions in the computer-readable storage medium, when executed by a processor of an electronic device, configure the electronic device to:
obtain M original images of a target scene captured by M image acquisition devices, wherein each image acquisition device of the M image acquisition devices provides a different viewpoint of the target scene, and M is a positive integer greater than or equal to 8;
perform, for each original image of the M original images, an image deformation process on the original image, based on depth information of the original image and internal and external parameters of the image acquisition device, to obtain a deformed image; and
perform a splicing process on M deformed images subjected to the image deformation process, to obtain an omni-directional stereo panoramic image.

16. The non-transitory computer-readable storage medium according to claim 15, wherein the instructions configuring the electronic device to obtain M original images of a target scene captured by M image acquisition devices comprise instructions to configure the electronic device to:
determine a center point of a pupil distance between a left eye and a right eye of a first device as a center point of an omni-directional stereo camera coordinate system;
arrange two image acquisition devices of the M image acquisition devices to be at a top and a bottom of the first device in a vertical direction, based on the center point of the omni-directional stereo camera coordinate system, to obtain a top image and a bottom image; and
divide an omni-directional stereo field-of-view circle into N equal parts in a horizontal direction, based on the center point of the omni-directional stereo camera coordinate system, and arrange 2N image acquisition devices to be at the N equal parts in a tangential manner, to obtain N left-eye images and N right-eye images, wherein N is a positive integer greater than or equal to 3 and less than M.

17. The non-transitory computer-readable storage medium according to claim 16, wherein in a case that N is equal to 4, M is equal to 10.

18. The non-transitory computer-readable storage medium according to claim 16, wherein the instructions configuring the electronic device to perform, for each original image of the M original images, the image deformation process on the original image, based on depth information of the original image and internal and external parameters of the image acquisition device, to obtain the deformed image comprise instructions to configure the electronic device to:
convert pixel coordinates of each mesh vertex of the original image into camera three-dimensional coordinates in the omni-directional stereo camera coordinate system, based on the depth information and the internal and external parameters of the image acquisition device;
convert the camera three-dimensional coordinates in the omni-directional stereo camera coordinate system into spherical three-dimensional coordinates in the omni-directional stereo spherical coordinate system, and generate a three-dimensional mesh model based on the spherical three-dimensional coordinates; and
perform a mesh smoothing process on the three-dimensional mesh model, and flatten the three-dimensional mesh model subjected to the mesh smoothing process, to obtain an omni-directional stereo flat mesh model as the deformed image.

19. The non-transitory computer-readable storage medium according to claim 18, wherein the instructions configuring the electronic device to perform the mesh smoothing process on the three-dimensional mesh model comprise instructions to configure the electronic device to:
iteratively optimize the three-dimensional mesh model for multiple times by a mesh smoothing algorithm, to obtain an optimized three-dimensional mesh model.

20. The non-transitory computer-readable storage medium according to claim 18, wherein the instructions configuring the electronic device to perform the splicing process on the M deformed images subjected to the image deformation process, to obtain the omni-directional stereo panoramic image comprise instructions to configure the electronic device to:
render M omni-directional stereo flat mesh models based on color information of the original images, to obtain the omni-directional stereo panoramic image.
